(19) United States
(12) Patent Application Publication
(10) Pub. No.: US 2001/0026242 A1
(43) Pub. Date: Oct. 4, 2001

(54) Primary radiator having improved receiving efficiency by reducing side lobes

(75) Inventors: Keiichiro Sato, Fukushima-ken (JP); Toshiaki Konno, Fukushima-ken (JP); Dou Yuanzhu, Fukushima-ken (JP); Shuji Saito, Miyagi-ken (JP)

Correspondence Address: BRINKS HOFER GILSON & LIONE, P.O. BOX 10395, CHICAGO, IL, 60610, US

(73) Assignee: Alps Electric Co., Ltd.

(21) Appl. No.: 09/821,372

(22) Filed: Mar. 29, 2001

(30) Foreign Application Priority Data
Mar. 31, 2000 (JP) 2000-099254
Mar. 31, 2000 (JP) 2000-099261

(51) Int. Cl. H01Q 13/00

(52) U.S. Cl. 343/786; 343/772; 343/785

(57) ABSTRACT

A radiation section of a dielectric feeder protrudes from an opening of a waveguide to improve the efficiency of receiving radio signals. An opening is provided at one end of the waveguide. A dielectric feeder held within the waveguide has a radiation section protruding from the opening. An annular wall having a bottom surrounds the opening of the waveguide. The depth of the annular wall is about ¼ of the wavelength of radio waves, and the width of a bottom surface of the annular wall is about ⅙ to 1/10 of the wavelength of the radio waves. Consequently, the phases of a surface current that flows from the opening toward the bottom surface of the annular wall and a surface current which flows from the bottom surface of the annular wall toward the open end are substantially out of phase. As a result, the side lobes of the received radio signals are greatly reduced, and the gain of the main lobe is increased, improving the reception of radio waves transmitted from a satellite.

### BACKGROUND OF THE INVENTION

1. Field of the Invention

The present invention relates to a primary radiator used in a satellite antenna, etc., and, more particularly, to a primary radiator using a dielectric feeder.

2. Description of the Related Art

FIG. 16 is a sectional view of a conventional primary radiator using a dielectric feeder. The primary radiator comprises a waveguide 10 that has an open end and a closed end. The closed end is bounded by a surface 10a. A dielectric feeder 11 is held in an opening 10b of the waveguide 10. Inside the waveguide 10, a first probe 12 and a second probe 13 are positioned orthogonal to each other, and the distance between these probes 12 and 13 and the surface 10a is approximately ¼ of the guide wavelength.

The dielectric feeder 11 is made of a dielectric material, such as polyethylene. A radiation section 11b and an impedance conversion section 11c are formed at ends of the dielectric feeder 11 which has a holding section 11a as a boundary formed therebetween. The outer diameter of the holding section 11a is nearly the same as the inner diameter of the waveguide 10, and the dielectric feeder 11 is fixed to the waveguide 10 by the holding section 11a. Both the radiation section 11b and the impedance conversion section 11c have a conical shape. The radiation section 11b protrudes outward from the opening 10b of the waveguide 10, and the impedance conversion section 11c extends to an interior of the waveguide 10.

The primary radiator described above is disposed at a focal position of a reflecting mirror of a satellite reflection-type antenna. In this device, radio waves transmitted from a satellite are focused to the inside of the dielectric feeder 11 from the radiation section 11b. Impedance matching is performed by the impedance conversion section 11c of the dielectric feeder 11. The radio waves travel into the interior of the waveguide 10. When the radio waves are received by the first probe 12 and the second probe 13, the received signal is frequency-converted into an IF frequency signal by a converter circuit (not shown).

As illustrated by the dashed line in FIG. 15, the radiation pattern received by the primary radiator described above contains side lobes. The side lobes are formed because a surface current flows to the outer surface of the waveguide 10 and is radiated due to the discontinuity of the impedance that lies within the opening 10b. For example, when the designed radiation angle of the radiation section 11b is 90 degrees (i.e., ±45 degrees with respect to the center), high amplitude side lobes are generated in the range of ±50 degrees. Because the gain of the main lobe in the central portion of the radiation angle is decreased, the radio waves from the satellite are not received efficiently.

### SUMMARY OF THE INVENTION

According to a first aspect, a primary radiator comprises a waveguide having an opening at one end that receives a dielectric feeder. The dielectric feeder is held within the waveguide. A radiation section is formed such that a portion protrudes from the opening of the waveguide. An annular wall having a bottom wall and an opening, is provided adjacent to the waveguide. The depth of the annular wall is about ¼ of the wavelength of the radio waves. Preferably, the width of a bottom surface of the annular wall is about ⅙ to 1/10 of the wavelength of the radio waves.

According to a second aspect, the phases of a surface current flowing on the outer surface of the opening of the waveguide and a surface current flowing on the inner surface of the annular wall are about one hundred and eighty degrees out of phase. Accordingly, the currents substantially cancell, the amplitude of the side lobes are greatly reduced, and the gain of the main lobe is increased. Furthermore, if a plurality of annular walls are provided concentrically, the amplitude of the side lobes are also reduced.

According to a third aspect, a primary radiator comprises a waveguide having an opening at one end that receives a dielectric feeder that is held within the waveguide. A radiation section is formed such that a portion protrudes from the opening of the waveguide. A gap having a depth of about ¼ of the wavelength of the radio waves is provided between an inner wall surface of the opening of the waveguide and the outer surface of the dielectric feeder.

In this aspect, the phases of a surface current flowing on the outer surface of the dielectric feeder and a surface current flowing on the inner surface of the waveguide are substantially out of phase and cancel or substantially cancel each other. As a result, the side lobes are greatly reduced, and the gain of the main lobe is increased.

In a fourth aspect, the gap can be formed by making the opening of the waveguide protrude outward. The gap is formed within recessed sections in which the outer surface of the dielectric feeder is cut out. In this aspect, preferably, the width (i.e., the facing distance between the dielectric feeder and the waveguide) of the gap is about ⅙ to 1/10 of the diameter of the opening of the waveguide.

Although the gap can be provided around the entire periphery of the inner wall surface of the opening of the waveguide in the above described aspects, the gap also may be provided in a portion of the inner wall surface of the opening of the waveguide when a symmetry is substantially maintained. In this aspect, preferably, a plurality of recessed sections are formed on the outer surface of the dielectric feeder, and the projection portions between recessed sections are coupled to the inner wall surface of the opening of the waveguide. In this arrangement, the holding strength of the dielectric feeder increases.

### BRIEF DESCRIPTION OF THE DRAWINGS

FIG. 1 is a sectional view of a primary radiator according to a first embodiment;

FIG. 2 is a right side view of FIG. 1;

FIG. 3 is a main portion of FIG. 1;

FIG. 4 is a sectional view of a primary radiator according to a second embodiment;

FIG. 5 is a right side view of FIG. 4;

FIG. 6 is a sectional view of a primary radiator according to a third embodiment;

FIG. 7 is a right side view of FIG. 6;

FIG. 8 is a main portion of FIG. 6;

FIG. 9 is a sectional view of a primary radiator according to a fourth embodiment;

FIG. 10 is a sectional view of a primary radiator according to a fifth embodiment;

FIG. 11 is a right side view of FIG. 10;

FIG. 12 is a sectional view taken along the line XII-XII of FIG. 10;

FIG. 13 is a front view of a dielectric feeder within a primary radiator;

FIG. 14 is a left side view of FIG. 13;

FIG. 15 is a comparison of radiation patterns of a conventional example to an embodiment; and

FIG. 16 is a sectional view of a conventional primary radiator.

### DESCRIPTION OF THE PREFERRED EMBODIMENTS

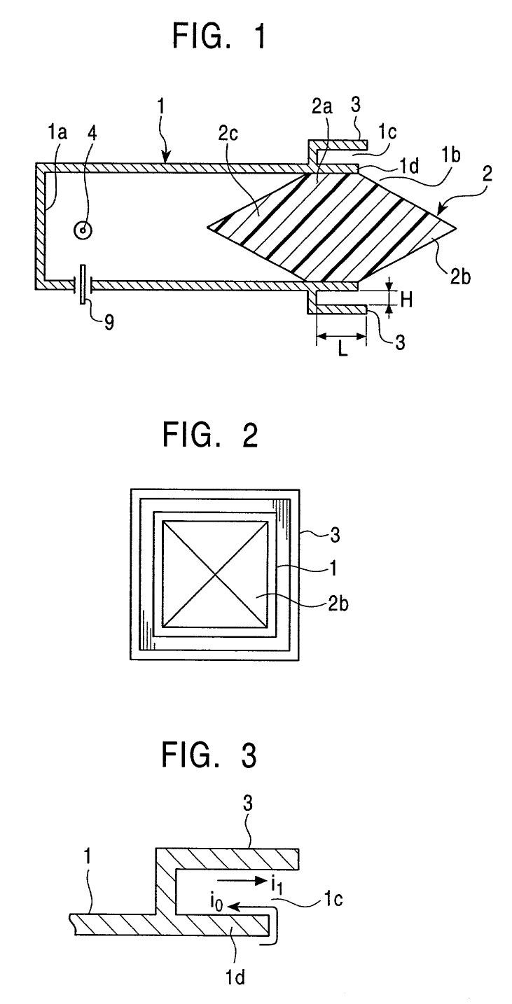

As shown in FIGS. 1 and 2, a primary radiator according to a first embodiment comprises a waveguide 1 having a rectangular cross section. The waveguide 1 has an open end and a closed end. The closed end is bounded by a closed surface 1a. A dielectric feeder 2 is partially held within an opening 1b of the waveguide 1. An annular wall 3 is positioned adjacent to the opening 1b. Inside the waveguide 1, a first probe 4 and a second probe 9 are orthogonal to each other, and the distance between probes 4 and 9 and the closed surface 1a is about ¼ of the guide wavelength λ_{g}. The probes 4 and 9 are connected to a converter circuit (not shown).

In this embodiment, the waveguide 1 is a unitary part of the annular wall 3, integrally molded through an aluminum die casting, etc. In alternative embodiments, the annular wall 3 can be welded, glued, or mechanically coupled to the outer surface of the waveguide 1. Preferably, the annular wall 3 has a bottom wall, and an opening 1c that is adjacent to the waveguide opening 1b. In this arrangement, the inlets that access the openings 1b and 1c are positioned on a common side of waveguide 1. If the depth of the annular wall 3 is denoted as L, the dimension L is about ¼ of the wavelength λ of the radio waves propagating within the annular waveguide 1. Furthermore, if the width, which is the space between the outer surface of the waveguide 1 and the inner surface of the annular wall 3 is denoted as H, the dimension H is about ⅙ to 1/10 of the wavelength λ of the radio waves.

The dielectric feeder 2 is preferably made of a dielectric material, such as polyethylene, for example. A radiation section 2b is coupled to an impedance conversion section 2c through a holding section 2a. The holding section 2a has a prism shape that can be press fitted or bonded within the waveguide 1. In this embodiment, the radiation section 2b and the impedance conversion section 2c have pyramid shapes. The radiation section 2b protrudes outward from the opening 1b of the waveguide 1 and the impedance conversion section 2c extends to an interior of the waveguide 1.

Radio waves transmitted from a satellite are received by a reflecting mirror of an antenna (not shown). The reflecting mirror reflects the radio waves into the primary radiator. The radio waves travel through the radiation section 2b into the interior of the dielectric feeder 2, which focuses the radio waves. The impedance conversion section 2c matches the impedance of the interior of the waveguide 1 which ensures an efficient transfer of the radio waves to the interior of the waveguide 1. The radio waves then are coupled to the first probe 4 and the second probe 9 before the signals are frequency-converted into an IF frequency signal by a converter circuit (not shown).

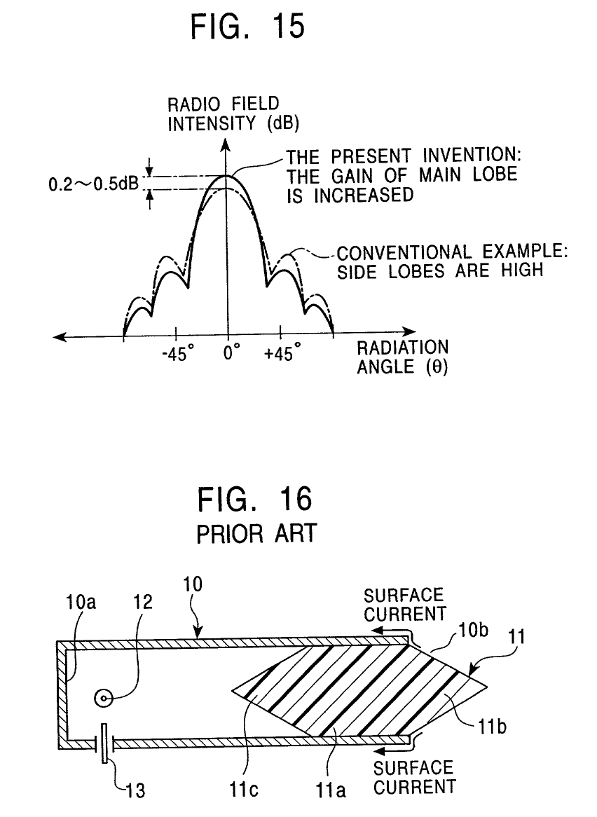

Since the annular wall 3, having a depth of about ¼ of the radio wave wavelength, surrounds the outer side of the opening 1b in this embodiment, the phases of a surface currents cancel. Surface current iₒ which flows on the outer surface 1d of the waveguide 1 toward the bottom surface of the annular wall 3 and surface current i₁ which flows on an inner surface of the annular wall 3 from the bottom surface toward the inlet end are substantially out of phase, and thus cancel. As a result, side lobes of radio field intensity are reduced when compared to the conventional example shown as a dashed line in FIG. 15. Consequently, in this embodiment, the gain of the main lobe is increased by about 0.2 to 0.5 dB, which improves the reception of satellite radio waves.

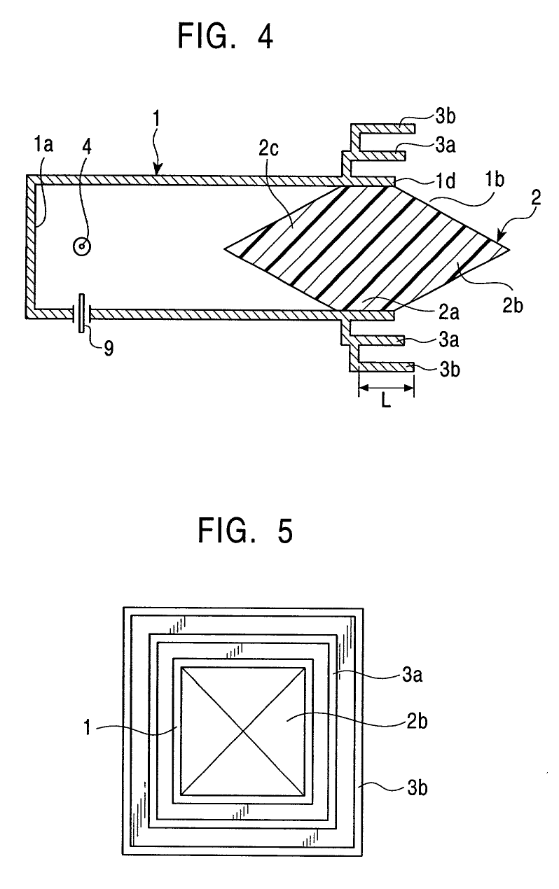

In the second embodiment shown in FIGS. 4 and 5, two annular walls 3a and 3b are positioned concentrically outside the opening 1b of the waveguide 1. That is, the first annular wall 3a surrounds the opening 1b of the waveguide 1, and the second annular wall 3b surrounds the first annular wall 3a. In this embodiment, the dimension L which is the interior length of the annular walls 3a and 3b is about ¼ of the wavelength of the radio waves, and the dimension H is about ⅙ to 1/10 of the wavelength of the radio waves. Accordingly, if a portion of a surface current flows from outer surface 1d of the waveguide 1 to the second annular wall 3b, that surface current is cancelled by the current flowing from second annular wall 3b. This embodiment further reduces the side lobes depicted in FIG. 15.

Many other alternative are also possible. For example, the primary radiator may also receive a waveguide 1 having a circular cross section. In this embodiment, annular walls may be concentrically provided outside the circular opening of the waveguide 1. Furthermore, three or more annular walls may concentrically surround the circular opening.

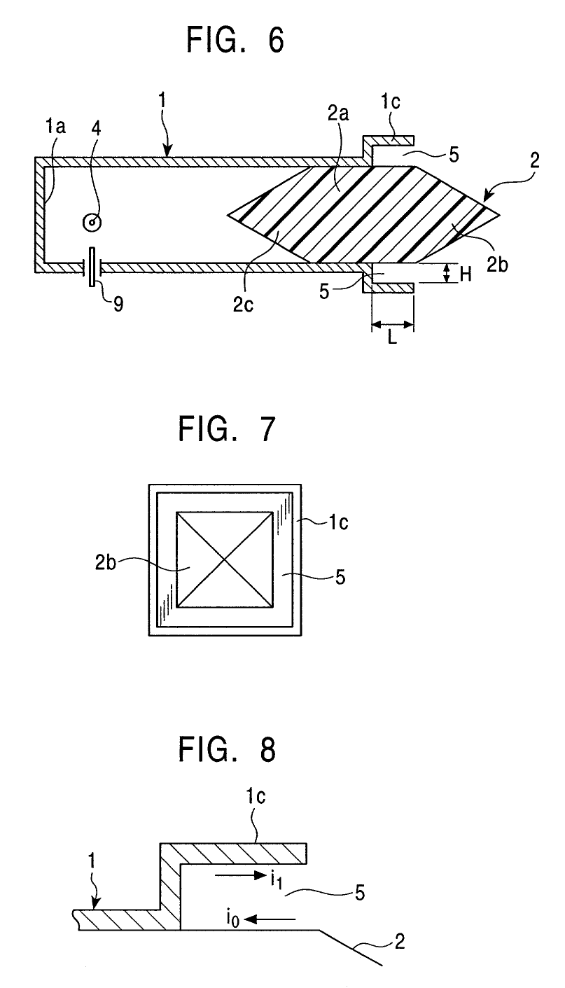

As shown in FIGS. 6 and 7, the primary radiator according to a third embodiment comprises a waveguide 1 having a rectangular cross section. One end of the waveguide 1 terminates at an opening and the other end terminates at a closed surface 1a. A dielectric feeder 2 is held within the waveguide 1. The dielectric feeder 2 preferably includes an expanded section 1c positioned near the open end of the waveguide 1. The expanded section 1c preferably increases the opening portion of the waveguide 1 at an outer edge. Preferably, the cross-sectional size or diameter of the opening of the expanded section 1c is greater than the cross-sectional size or diameter of a main portion of the waveguide 1. Inside the waveguide 1, a first probe 4 is positioned orthogonal to a second probe 9 that passes through the interior and exterior surfaces of the waveguide 1 wall. Preferably, the distance between probes 4 and 9 and the closed surface 1a is about ¼ of the guide wavelength λ_{g}. In this embodiment, the probes 4 and 9 are connected to a converter circuit (not shown).

The dielectric feeder 2 is preferably made of a dielectric material, such as polyethylene for example. A radiation section 2b and an impedance conversion section 2c are formed at the ends of the dielectric feeder 2 with a holding section 2a formed near the center of the dielectric feeder 2 which acts as a boundary. In this embodiment, the holding section 2a has a prism shape and the outer dimension thereof is nearly the same dimension as an interior portion of the waveguide 1, which is separate from the expanded section 1c. The holding section 2a is fixed inside the waveguide 1 preferably by a press fitting, an adhesive, or a bonding.

An annular gap 5 is created between the expanded section 1c of the waveguide 1 and the outer surface of the dielectric feeder 2. If the depth of the gap 5 (the length of the interior surface of the expanded section 1c along an axial direction) is denoted as L, and the width of the gap 5 (the width of the interior bottom surface of the expanded section 1c) is denoted as H, the dimension L is preferably about ¼ of the wavelength λ_{ε} of the radio waves propagating through the dielectric feeder 2, and the dimension H is preferably about ⅙ to 1/10 of the opening diameter of the expanded section 1c. Both the radiation section 2b and the impedance conversion section 2c have a pyramid shape. In this embodiment, the radiation section 2b protrudes outward from the expanded section 1c of the waveguide 1, and the impedance conversion section 2c extends into the interior of the waveguide 1.

When radio waves are transmitted from a satellite, the radio waves are received by the reflecting mirror of an antenna (not shown). The reflecting mirror reflects the radio waves into the primary radiator. The radio waves travel through the radio section 2b into the interior of the dielectric feeder 2, which focuses the radio waves. An impedance matching is then performed by the impedance conversion section 2c before the radio waves travel into the interior of the waveguide 1. The radio waves then are coupled to the first probe 4 and the second probe 9 before the signals are frequency-converted into an IF frequency signal by a converter circuit (not shown).

Since the gap 5 having a depth of about λ_{ε}/4 of the radio waves wavelength is created between the expanded section 1c of the waveguide 1 and the outer surface of the dielectric feeder 2, as shown in FIG. 3, the surface currents cancel. The phases of the surface current iₒ which flows on the outer surface of the dielectric feeder 2 toward the bottom surface and the surface current i₁, which flows on the inner surface of the opening 1b toward the open end are substantially 180 degrees or directly out of phase and thus, cancel each other. As a result, as shown by the solid line in FIG. 15, the side lobes are greatly reduced in comparison to the conventional example illustrated by the dashed line. Consequently, the gain of the main lobe is increased by about 0.2 to 0.5 dB in this embodiment, making it possible to efficiently receive radio waves from the satellite.

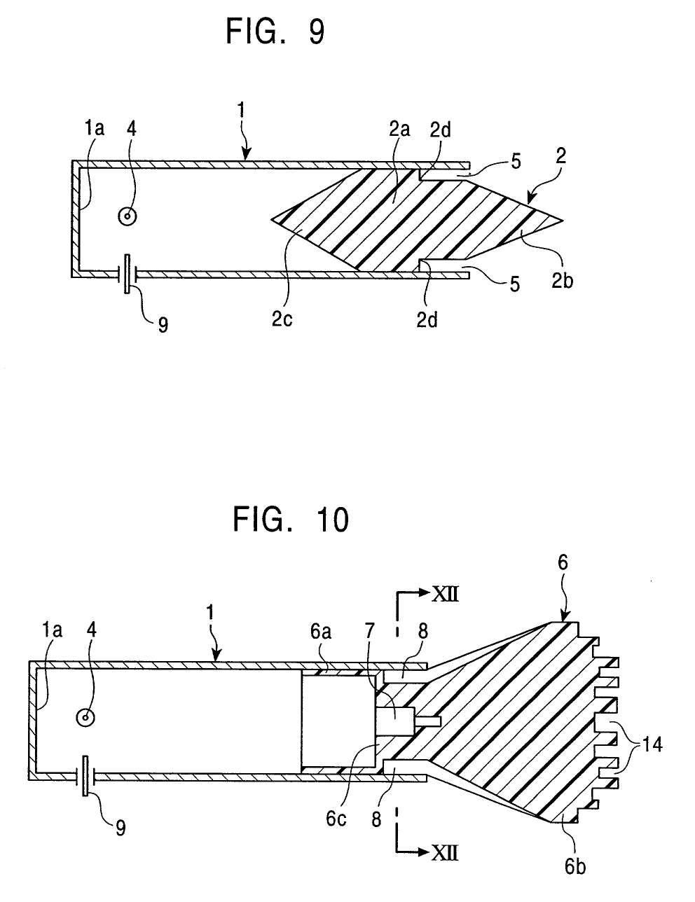

In a fourth embodiment shown in FIG. 9, the waveguide 1 has a substantially straight interior in which the cross-sectional size of the opening of each section are substantially equal. A step like difference 2d is formed in a boundary portion between the holding section 2a and the radiation section 2b of the dielectric feeder 2. An annular gap 5 is formed by this step like difference 2d between the inner wall of the opening of the waveguide 1 and the outer surface of the dielectric feeder 2.

In this embodiment the waveguide 1 has a substantially straight shape. When the waveguide 1 is, for example, molded by an aluminum die casting, etc., the die construction can be simplified. However, the waveguide 1 can be manufactured by many other ways such as by pressing a metal sheet. Accordingly, manufacturing costs can be reduced when making this embodiment.

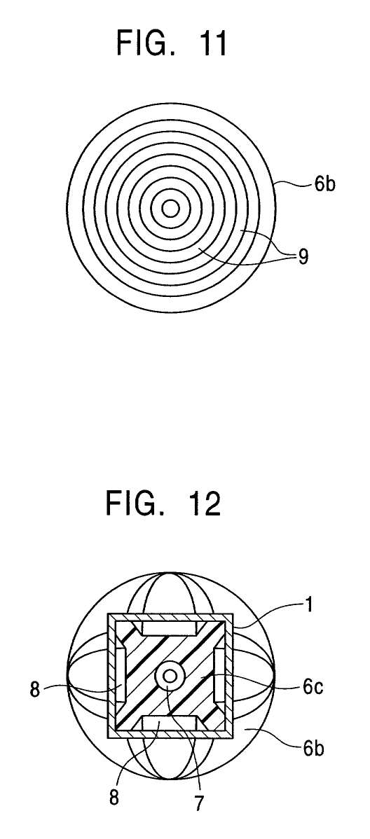

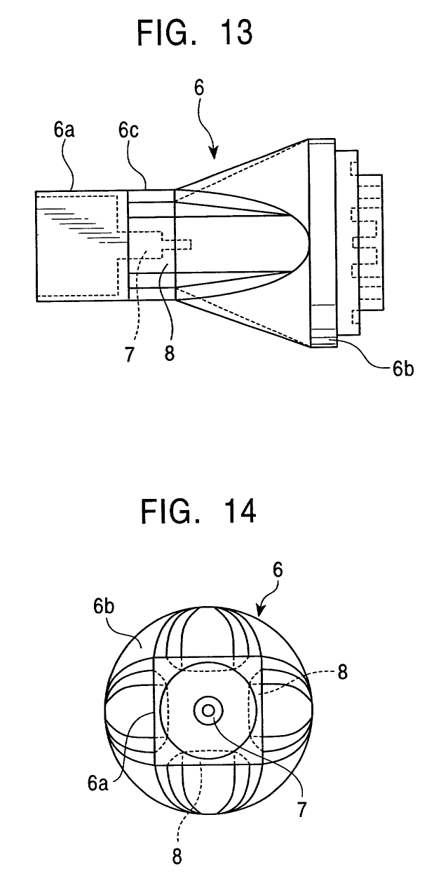

As shown in FIGS. 10 to 14, in the primary radiator of a fifth embodiment, the waveguide 1 has a substantially straight shape having a rectangular cross section. A dielectric feeder 6 comprises a holding section 6a having a hollow rectangular interior, an impedance conversion section 6c which is continuous with the holding section 6a, and a horn-shaped radiation section 6b which is continuous with the impedance conversion section 6c.

The outer dimension of the holding section 6a is nearly the same size as the opening of the waveguide 1 in this embodiment. Holding section 6a is inserted from the open end of the waveguide 1 and is fixed to an interior of the waveguide 1 by any suitable means such as press fitting or bonding. Inside the impedance conversion section 6c, a stepped hole 7 is formed by two cylindrical holes, one small hole and one large hole that together extend toward the radiation section 6b. Preferably, the depth of the two cylindrical holes are about ¼ of the wavelength λ_{ε} of the radio waves that propagate inside the dielectric feeder 6.

Recessed portions 8 are formed on four mutually perpendicular outer surfaces of the impedance conversion section 6c in this embodiment. Preferably, each recessed portion 8 extends along a peripheral surface, which extends into the horn shape of the radiation section 6b. The impedance conversion section 6c is inserted from the open end of the waveguide 1 and is held by the inner wall of the waveguide 1 at four projecting corners positioned between recessed portions 8. As a result, in the portion from the holding section 6a to the open end of the waveguide 1, each recessed portion 8 faces the inner wall surface of the waveguide 1 with a predetermined spacing (see FIG. 12). In alternative embodiments, the spacing may be substantially equal. The depth and the width of the gap defined by each recessed portion 8 are positioned a manner that is substantially similar to the gap 5 described in the third and fourth embodiments. Furthermore, the radiation section 6b protrudes outward from the open end of the waveguide 1. A plurality of annular grooves 14 is formed concentrically in the end surface of the radiation section 6b, and the depth of each annular groove 14 is about ¼ of the wavelength λ₀ of the radio waves in this embodiment.

Because a gap having a depth of about λ_{ε}/4 wavelength is provided by each recessed portion 8 positioned inside the opening of the waveguide 1 in the fifth embodiment, the phases of the surface current that flows on the outer surface of the impedance conversion section 6c toward the holding section 6a of the dielectric feeder 6 and a surface current which flows on the inner surface of the waveguide 1 from the holding section 6a toward the open end of the waveguide 1 are substantially out of phase and cancel each other. Furthermore, since a plurality of recessed portions 8 is formed on the outer surface of the dielectric feeder 6 with the projecting portions remaining on the outer surface of the dielectric feeder 6, and these projecting portions are held to the inner wall of the waveguide 1, the holding strength of the dielectric feeder 6 can be increased. In addition, since the stepped hole 7 that functions as the impedance conversion section 6c is within the dielectric feeder 6, the overall length of the dielectric feeder 6 can be shortened, and the size of the primary radiator can be reduced.

However, the primary radiator is not limited to the above-described embodiments and many alternatives are possible. For example, the cross sectional shape of the waveguide 1 and the dielectric feeder 6 may be circular in addition to many other shapes.

In the primary radiator in which the radiation section of the dielectric feeder protrudes from the opening of the waveguide, and an annular wall is formed to include a bottom and an open end adjacent to the opening of the waveguide, and the depth of this annular wall is about ¼ of the wavelength of the radio waves, the phases of a surface current which flows on the outer surface of the opening of the waveguide and a surface current which flows on the inner surface of the annular wall are substantially out of phase and cancel. Accordingly, the side lobes are greatly reduced, and the gain of the main lobe is increased improving satellite reception.

In the primary radiator in which the radiation section of the dielectric feeder protrudes from the opening of the waveguide, and a gap having a depth of about ¼ of the wavelength of the radio waves is provided between the inner surface of the opening of the waveguide and the outer surface of the dielectric feeder, the phases of a surface current which flows on the outer surface of the dielectric feeder and a surface current which flows on the inner surface of the waveguide are substantially out of phase and cancel each other in the gap. Accordingly, the side lobes of a received radio signal are greatly reduced, and the gain of the main lobe is increased improving reception of satellite signals.

Given that the openings and gaps are formed by structures that substantially cancel current that flow on an exterior or interior surface of the dielectric feeder 2, the invention encompasses any structure that achieves that function. Accordingly, any structure that creates a current that is about 180 degrees or a multiple of about 180 degrees (e.g. about 180*n, where “n” is an integer) out of phase with the current that flows on the exterior or interior surface of the dielectric feeder may be used in alternative embodiments.

Many other embodiments of the invention may be constructed without departing from the spirit and scope of the invention. It should be understood that the present invention is not limited to the embodiments described in this specification. To the contrary, the invention covers various modifications and equivalent arrangements included within the spirit and scope of the invention as claimed.

What is claimed is:

1. A primary radiator comprising:
a waveguide having a first opening at an end; and
a dielectric feeder held within the waveguide in which a radiation section of the dielectric feeder protrudes from the first opening,
wherein an annular wall surrounds a second opening and couples the waveguide through a bottom wall, wherein the second opening is positioned adjacent to the first opening of the waveguide, and the depth of the annular wall is about ¼ of a wavelength of a received radio wave.

2. A primary radiator according to claim 1, wherein the width of a bottom surface of the annular wall is about ⅙ to 1/10 of the wavelength of the received radio wave.

3. A primary radiator according to claim 1, wherein a plurality of annular walls surround the first opening.

4. A primary radiator according to claim 2, wherein a plurality of annular walls surround the first opening.

5. A primary radiator comprising:
a waveguide having an opening at an end; and
a dielectric feeder held within the waveguide and comprising a radiation section protruding from the opening,
wherein a gap having a depth of about ¼ of the wavelength of a plurality of radio waves is positioned between an inner wall surface of the opening of the waveguide and an outer surface of the dielectric feeder.

6. A primary radiator according to claim 5, wherein the width of the gap is about ⅙ to 1/10 of a diameter of the opening.

7. A primary radiator according to claim 5, wherein the gap surrounds the entire periphery of the inner wall surface of the opening.

8. A primary radiator according to claim 6, wherein the gap surrounds the entire periphery of the inner wall surface of the opening.

9. A primary radiator according to claim 5, wherein a plurality of recessed sections is formed on the outer surface of the dielectric feeder, and the gap is formed in part by the recessed sections.

10. A primary radiator according to claim 6, wherein a plurality of recessed sections is formed on the outer surface of the dielectric feeder, and the gap is formed in part by at least the recessed sections.

11. A primary radiator comprising:
a waveguide comprising a wall that terminates at an open end; and
a dielectric feeder coupled within the waveguide and comprising a radiation section protruding from the open end,
wherein the wall encloses a gap, the gap having a depth configured to generate a first current which is about 180 degrees out of phase with a second current that flows on the waveguide within the gap.

12. The primary radiator of claim 11 wherein the first current substantially cancels the second current.

13. The primary radiator of claim 11 wherein the depth comprises about ¼ of the wavelength of a received radio signal.

14. The primary radiator of claim 11 wherein the first and the second current flows within the waveguide.
